(19) United States
(12) Patent Application Publication
(10) Pub. No.: US 2010/0257062 A1
(43) Pub. Date: Oct. 7, 2010

(54) PROVIDING RECOMMENDATIONS FOR TRAFFICKING ONLINE ADS IN AN ONLINE AD NETWORK

(75) Inventors: Vivek Hariharan, Sunnyvale, CA (US); Durgadatt R. Kamath, Cupertino, CA (US); Brian Lam, San Jose, CA (US); Graham S.T. Harris, Westlake Village, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/418,027

(22) Filed: Apr. 3, 2009

(51) Int. Cl. G06Q 30/00; G06F 17/30

(52) U.S. Cl. 705/14.73; 707/E17.014

(57) ABSTRACT

Systems, methods, and computer program products are described that provide recommendations for trafficking online advertisements (“ads”) in an online ad network. In a first example implementation, online ads are recommended for trafficking with regard to designated placements. In another example implementation, placements are recommended for trafficking designated online ads. Placements may be associated with ad groups, such that the ad groups may be recommended for assignment of designated online ads, and/or online ads may be assigned to designated ad groups.

### BACKGROUND OF THE INVENTION

1. Field of the Invention

The present invention generally relates to online advertising. In particular, the present invention is related to providing recommendations for trafficking online advertisements (“ads”) in an online ad network.

2. Background

Certain online advertisement (“ad”) networks enable online ads to be served to users visiting the Web sites of publishers that are participating in the online ad network. Advertisers generate the online ads and buy placements (a.k.a. inventory) for those ads on the publishers' Web sites usually based on the anticipated audiences for those sites. A placement represents a publisher's agreement to serve a trafficked (i.e., specified) ad to users when the users visit the publisher's site. The publisher often serves the trafficked ad contemporaneously with other content associated with the publisher's site.

Each time a user visits a Web site, an impression is said to occur. The impression causes an ad call (also referred to as an impression call) to be generated. The ad call initiates retrieval of the trafficked ad, which the publisher serves to the user in fulfillment of the purchased placement.

The process of trafficking online ads in a conventional online ad network requires substantial involvement of an advertiser (or representative thereof) and becomes more burdensome as the number of ads and/or placements increases. For example, if the advertiser wishes to determine which ads should be trafficked with regard to designated placements, the advertiser traditionally searches or browses through a database of the advertiser's ads to determine which ads satisfy the requirements of the designated placements. Similarly, if the advertiser wishes to determine which placements have requirements that are satisfied by designated online ads, the advertiser traditionally searches or browses through a database of placements to determine which placements to select for trafficking the designated online ads. Accordingly, the time and cost associated with trafficking online ads in a conventional online ad network may substantially limit the ability of the advertiser to focus on other tasks, such as researching, creating new ads, etc.

Thus, systems, methods, and computer program products are needed that provide recommendations for trafficking online ads.

### BRIEF SUMMARY OF THE INVENTION

Systems, methods, and computer program products are described herein for providing recommendations for trafficking online advertisements (“ads”) in an online ad network. Embodiments of the present invention recommend online ads for trafficking with regard to designated placements and/or recommend placements to which designated online ads may be trafficked.

By providing recommendations for trafficking online ads, an embodiment of the present invention can advantageously reduce the amount of involvement necessary for an advertiser (or representative thereof) to traffic online ads, as compared to conventional online ad networks.

In particular, a system is described that includes a processing module and storage, which is coupled to the processing module. The storage stores a database module, a first recommendation operation module, and a second recommendation operation module. The database module includes online advertisements and placements. The first recommendation module enables the processing module to compare at least one required attribute of a placement and at least one attribute of an online advertisement to determine that the at least one required attribute of the placement matches the at least one attribute of the online advertisement. The second recommendation operation module enables the processing module to recommend that the online advertisement is trafficked with regard to the placement in response to the at least one required attribute of the placement matching the at least one attribute of the online advertisement.

Three methods are also described herein. In the first method, at least one required attribute of a placement and at least one attribute of an online advertisement are compared to determine that the at least one required attribute of the placement matches the at least one attribute of the online advertisement. A recommendation is made that the online advertisement is trafficked with regard to the placement in response to the at least one required attribute of the placement matching the at least one attribute of the online advertisement.

In the second method, data descriptive of a placement having at least one required attribute is received. A database is searched to determine one or more online advertisements having the at least one required attribute. The one or more online advertisements are recommended for trafficking with regard to the placement.

In the third method, data descriptive of an online advertisement having attributes is received. A database is searched to determine one or more placements, each having required attributes that are satisfied by the respective attributes of the online ad. The one or more placements are recommended for trafficking the online advertisement.

A computer program product is also described herein. The computer program product includes a computer-readable medium having computer program logic recorded thereon for enabling a processor-based system to recommend one or more online advertisements for trafficking. The computer program logic includes a first program logic module and a second program logic module. The first program logic module is for enabling the processor-based system to compare at least one required attribute of a placement and at least one attribute of each of a plurality of online advertisements to determine that the at least one required attribute of the placement matches the at least one attribute of one or more advertisements of the plurality of online advertisements. The second program logic module is for enabling the processor-based system to recommend the one or more advertisements for trafficking with regard to the placement in response to the at least one required attribute of the placement matching the at least one attribute of the one or more advertisements.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example online advertisement (“ad”) network in accordance with an embodiment of the present invention.

FIG. 2 is a block diagram of an example implementation of the ad recommendation module shown in FIG. 1 in accordance with an embodiment of the present invention.

FIG. 3 is a block diagram of an example implementation of the database module shown in FIG. 2 in accordance with an embodiment of the present invention.

FIGS. 4-6 depict flowcharts of methods for providing recommendations for trafficking online ads in accordance with embodiments of the present invention.

FIGS. 7 and 8 are illustrations of example Web pages showing a user interface for enabling a user to request a recommendation for trafficking online ad(s) and to view corresponding recommendations in accordance with embodiments of the present invention.

FIG. 9 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### II. Example Online Advertising Network

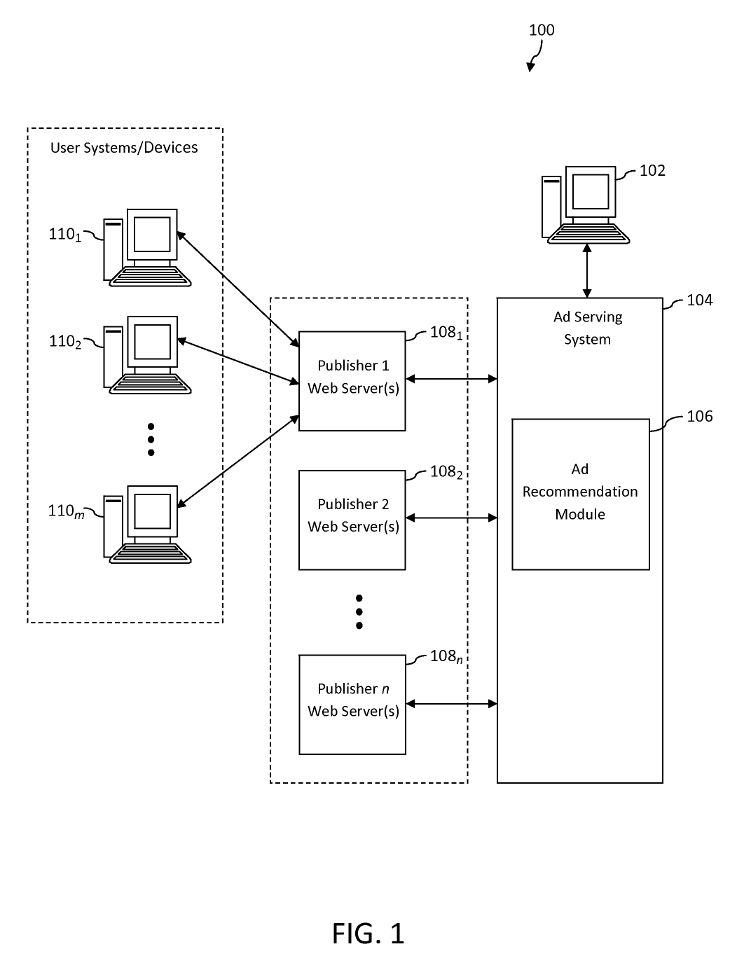

FIG. 1 is a block diagram of an example online advertisement (“ad”) network in accordance with an embodiment of the present invention. Generally speaking, online ad network 100 operates to serve online ads provided by advertisers to Web sites published by publishers when such Web sites are accessed by certain users of the network, thereby delivering the online ads to the users. As shown in FIG. 1, online ad network 100 includes at least one advertiser system/device 102, an ad serving system 104, a plurality of publisher Web servers 108₁-108ₙ, and a plurality of user systems/devices 110₁-110ₘ.

Each of publisher Web servers 108₁-108ₙ is configured to host a Web site published by corresponding publisher 1-n so that such Web site is accessible to users of network 100. A user may access such Web sites using a Web browser or other Web client installed on a system/device owned by or otherwise accessible to the user.

By way of example, FIG. 1 shows a plurality of user systems/devices 110₁-110ₘ, each of which executes a Web browser that enables a user to visit any of the Web sites hosted by publisher Web servers 108₁-108ₙ. As depicted in FIG. 1, each of client systems/devices 110₁-110ₘ is communicatively connected to publisher 1 Web server(s) 108₁ for the purpose of accessing a Web site published by publisher 1. Persons skilled in the relevant art(s) will recognize that each of user systems/devices 110₁-110ₘ is capable of connecting to any of publisher Web servers 108₁-108ₙ to access the Web sites hosted thereon. Communication between user systems/devices 110₁-110ₘ and publisher Web servers 108₁-108ₙ is carried out over a wide area network, such as the Internet, using well-known network communication protocols.

Ad serving system 104 is configured to deliver online ads received from an advertiser system/device 102 to each of publisher Web servers 108₁-108ₙ when the Web sites hosted by such Web servers are accessed by certain users, thereby facilitating the delivery of such online ads to the users. Before the online ads can be delivered to publisher Web servers 108₁-108ₙ, however, the online ads are trafficked with regard to respective placements. A placement represents a publisher's agreement to serve a trafficked ad to users when the users visit the publisher's site. In one embodiment, online ads may be organized and trafficked in groups, termed ad groups. An ad group may comprise, for example, a collection of online ads having a similar target audience and/or pricing model.

Ad recommendation module 106 advantageously provides recommendations for trafficking online ads. An advertiser (or representative thereof) uploads online ads to ad recommendation module 106 using a Web browser or other Web client installed on advertiser system/device 102, which is owned by or otherwise accessible to the advertiser. Advertiser system/device 102 executes the Web browser, enabling the advertiser to view the online ads and to request recommendations for trafficking one or more of the online ads.

For example, the advertiser may request recommendations of placements for trafficking one or more online ads that are designated by the advertiser. In response to the advertiser's request, ad recommendation module 106 recommends placements having required attributes that match the corresponding attributes of the designated online ads. The advertiser may accept the recommended placements, causing ad serving system 104 to traffic the designated online ads with regard to the respective recommended placements. Alternatively, the advertiser may search or browse through a database of available placements using the Web browser installed on advertiser system/device 102 to determine alternative placement(s) having required attributes that match the attributes of the respective designated online ad(s).

In further accordance with this example, ad recommendation module 106 may be configured to recommend ad groups to which the designated one or more online ads may be assigned. For example, ad recommendation module 106 may recommend the ad groups in response to matching attribute(s) of the designated one or more online ads with required attribute(s) of placements associated with the ad groups. The advertiser may accept a recommended ad group by assigning a designated online ad to the recommended ad group. The designated online ad may be assigned to another ad group in addition to, or in lieu of, the recommended ad group.

In another example, the advertiser may request recommendations of online ads for trafficking with regard to designated placements. In response, ad recommendation module 106 recommends one or more of the advertiser's online ads having attributes that match the corresponding required attributes of the designated placements. If the advertiser accepts a recommended online ad, the online ad is trafficked with regard to the respective designated placement. Otherwise, the advertiser searches or browses through a database of the advertiser's online ads to select an alternative online ad.

In further accordance with this example, ad recommendation module 106 may be configured to recommend online ads for assignment to a designated ad group that is associated with a plurality of placements. For instance, ad recommendation module 106 may recommend the online ads in response to matching attribute(s) of the recommended online ads with required attribute(s) of at least one placement of the plurality of placements. The advertiser may accept a recommended online ad by assigning the recommended online ad to the designated ad group. The advertiser may deny the recommended online ad by assigning an alternative online ad to the designated ad group.

Communication between advertiser system/device 102 and ad recommendation module 106 is carried out over a wide area network, such as the Internet, using well-known network communication protocols. Although one advertiser 102 system/device is depicted in FIG. 1, persons skilled in the relevant art(s) will recognize that any number of advertiser system/devices may be communicatively coupled to ad serving system 104. For instance, the functionality of ad recommendation module 106 may be accessible to one or more advertisers or representatives thereof via respective advertiser system/devices.

Although advertiser system/device 102 and user systems/devices 110₁-110ₘ are depicted as desktop computers in FIG. 1, persons skilled in the relevant art(s) will appreciate that advertiser system/device 102 and user systems/devices 110₁-110ₘ may include any browser-enabled system or device, including but not limited to a laptop computer, a personal digital assistant, a cellular telephone, or the like.

### III. Example Ad Recommendation Module

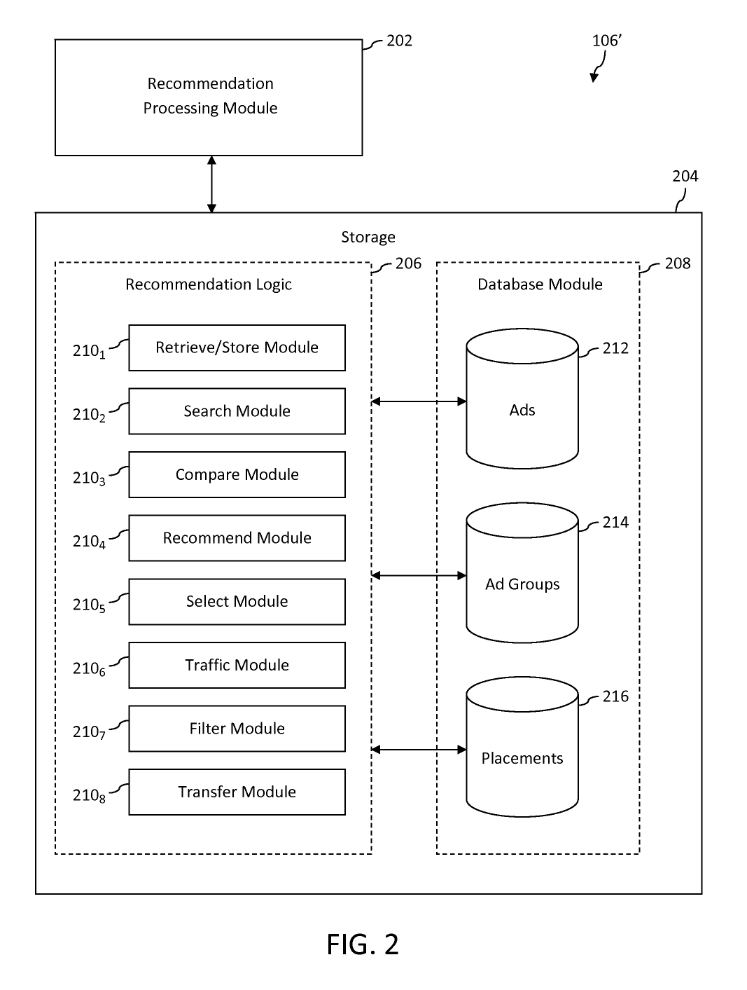

FIG. 2 is a block diagram of an example implementation 106′ of ad recommendation module 106 shown in FIG. 1 in accordance with an embodiment of the present invention. In FIG. 2, ad recommendation module 106′ includes a recommendation processing module 202 that includes one or more processors (e.g., one or more central processing units (CPUs)) and storage 204 that are communicatively connected for providing recommendations for trafficking online ads provided by one or more advertisers or representatives thereof via respective advertiser systems/devices, as shown of FIG. 1. Storage 204 includes recommendation logic 206 and a database module 208. Recommendation logic 206 includes recommendation operation modules 210₁-210₈, each of which includes instructions to enable recommendation processing module 202 to perform a respective recommendation operation. The instructions of each recommendation operation module need not necessarily be limited to that particular recommendation operation module. For instance, recommendation operation modules 210₁-210₈ may share instructions.

Example recommendation operations will now be discussed with reference to recommendation operation modules 210₁-210₈. When ad recommendation module 106′ receives online ads from an advertiser or representative thereof, recommendation processing module 202 stores the online ads in ads database 212 in accordance with instructions stored in retrieve/store module 210₁. When ad recommendation module 106′ receives data descriptive of placements being offered by a publisher, recommendation processing module 202 stores the data in placements database 216 in accordance with instructions stored in retrieve/store module 210₁. The data stored in placements database 216 include the required attributes of the respective placements.

Retrieve/store module 210₁ enables recommendation processing module 202 to store data descriptive of ad groups in ad groups database 214. The data stored in ad groups database 214 include data descriptive of online ads that are included in the respective ad groups and data descriptive of placements associated with the respective ad groups. For example, the data descriptive of the online ads may include pointers to the respective online ads stored in ads database 212, the attributes of the online ads, or other indicators that are descriptive of the online ads. The data descriptive of the placements may include pointers to the respective placements stored in placements database 216, the required attributes of the placements, or other indicators that are descriptive of the placements.

Although placements and ad groups may be referred to herein as being stored in respective placements database 216 and ad groups database 214 for ease of discussion, persons skilled in the relevant art(s) will recognize that the data associated with the respective placements and ad groups, rather than the placements and ad groups themselves, are stored in respective placements database 216 and ad groups database 214.

Search module 2102 enables recommendation processing module 202 to search ads database 212 for online ads having specified attribute(s), to search ad groups database 214 for ad groups associated with one or more placements having the specified attribute(s), and to search placements database 216 for placements having the specified attribute(s) in accordance with instructions stored in search module 2102. An advertiser may limit the scope of a search operation conducted in accordance with instructions stored in search module 210₂ by providing appropriate search criteria. For example, the advertiser may limit the search operation to online ads, ad groups, and/or placements specified by the advertiser. In another example, the advertiser may limit the search operation to certain folders of a hierarchical folder structure that includes the online ads, ad groups, and placements stored in respective ads database 212, ad groups database 214, and placements database 216.

Compare module 210₃ enables recommendation processing module 202 to compare attributes of online ads in ads database 212 with required attributes of placements stored in placements database 216 to determine whether the attributes of the online ads and the required attributes of the placements match. Recommendation processing module 202 may compare attributes of online ads in ads database 212 with required attributes associated with ad groups stored in ad groups database 214 in accordance with instructions stored in compare module 210₃. It should be noted that the required attributes associated with the ad groups may be characterized as required attributes of placements that are associated with the ad groups.

Recommend module 210₄ enables recommendation processing module 202 to recommend online ads for trafficking with regard to designated placements. For instance, recommendation processing module 202 may recommend one or more online ads for assignment to ad group(s) associated with the designated placements in accordance with instructions stored in recommend module 210₄. The recommendation may be provided in response to recommend processing module 202 matching attribute(s) of the one or more online ads with required attribute(s) of the designated placements in accordance with instructions stored in compare module 210₃. Recommendation processing module 202 enables an advertiser to select one or more of the recommended online ads for trafficking with regard to the designated placements in accordance with instructions stored in select module 210₅.

Recommend module 210₄ further enables recommendation processing module 202 to recommend placements for trafficking designated online ads. For example, recommendation processing module 202 may recommend assigning the designated online ads to one or more ad groups associated with respective placements having required attributes that match corresponding attributes of the designated online ads in accordance with instructions stored in recommend module 210₄. Recommendation processing module 202 enables the advertiser to select one or more of the recommended placements for trafficking the designated online ads in accordance with instructions stored in select module 210₅.

Recommendation processing module 202 enables the advertiser to traffic online ads that are stored in ads database 212 with regard to placements stored in placements database 216 in accordance with instructions stored in traffic module 210₆. For example, the advertiser may specify one of a plurality of recommended online ads (e.g., a recommended ad selected by the advertiser) for trafficking with regard to a designated placement. Recommendation processing module 202 traffics the specified online ad with regard to the designated placement in accordance with instructions stored in traffic module 210₆. In another example, the advertiser may specify one or more recommended placements (e.g., recommended placement(s) selected by the advertiser) for trafficking a designated online ad. Recommendation processing module 202 traffics the designated online ad with regard to the specified one or more recommended placements in accordance with instructions stored in traffic module 210₆.

Filter module 210₇ enables recommendation processing module 202 to filter recommended online ads, ad groups, and/or placements. For example, an advertiser may submit a command to remove a recommended online ad, ad group, or placement from a list of a plurality of respective recommended online ads, ad groups, or placements. In another example, the advertiser may submit a command to add a non-recommended online ad, ad group, or placement to the list of respective recommended online ads, ad groups, or placements. Recommendation processing module 202 filters the list of recommended ads, ad groups, and/or placements based on the advertiser's commands in accordance with instructions stored in filter module 210₇.

Filter module 210₇ may be operable in combination with search module 210₂, enabling the advertiser to search through the list of recommended online ads, ad groups, or placements to determine whether an online ad, ad group, or placement is to be removed or added to the respective list. For instance, recommendation processing module 202 may search the respective list by searching for a specified combination of characters (e.g., a word) in the name of the online ad, ad group, or placement or other attributes thereof in accordance with instructions stored in search module 210₂.

Although only a single ads database 212, a single ad groups database 214, and a single placements database 216 are shown in FIG. 2, persons skilled in the relevant art(s) will appreciate that the online ads, ad groups, and placements may be stored in multiple ads databases, multiple ad groups databases, and multiple placements databases, respectively.

In FIG. 2, recommendation logic 206 and database module 208 are shown to be included in a single storage 204 for illustrative purposes. However, it will be apparent to persons skilled in the relevant art(s) that storage 204 may include a plurality of storage systems, each storing at least a portion of recommendation logic 206 and/or database module 208. Any one or more processors of recommendation processing module 202 may be communicatively connected to respective portions of recommendation logic 206 and/or database module 208. For instance, transfer module 210₈ is configured to enable recommendation processing module 202 to transfer an online ad, ad group, or placement among the plurality of storage systems.

In one example implementation, a first server includes at least one processor of recommendation processing module 202 and one or more recommendation operation module(s) of recommendation logic 206. A second server includes another at least one processor of recommendation processing module 202, other recommendation operation module(s) of recommendation logic 206, and database module 208. The first server may receive online ads from advertiser system/device 102 and data descriptive of placements from publisher Web servers 108₁-108ₙ. A recommendation operation module, such as transfer module 210₈, stored on the first server may be configured to provide the online ads and placements to the second server for processing the online ads and placements in accordance with the recommendation techniques described herein. For instance, the recommendation operation module stored on the first server may provide the online ads and data descriptive of the placements to respective ads database 212 and placements database 216 of the second server. This example implementation is provided for illustrative purposes and is not intended to be limiting. It will be apparent to persons skilled in the relevant art(s) that other implementations fall within the scope of the present invention.

Storage 204 may be of any suitable type, including but not limited to random access memory (RAM), such as static RAM (SRAM), dynamic RAM (DRAM), ferroelectric RAM (FeRAM), magnetoresistive RAM (MRAM), resistive RAM (RRAM), or nano-RAM (NRAM); read only memory (ROM), such as programmable ROM (PROM), erasable programmable ROM (EPROM), or electrically erasable programmable ROM (EEPROM); flash memory; optical storage media, such as a compact disc (CD), digital versatile disc (DVD), or Blue-ray disc; programmable metallization cell (PMC); phase-change memory (PCM); silicon-oxide-nitride-oxide-silicon (SONOS); racetrack memory; etc.

Note that recommendation logic 206 may include any one or more of recommendation operation modules 210₁-210₈, each of which may be implemented in hardware, software, firmware, or any combination thereof. For example, any one or more of recommendation operation modules 210₁-210₈ may be implemented as computer code configured to be executed in one or more processors. In another example, any one or more of recommendation operation modules 210₁-210₈ may be implemented as hardware logic/electrical circuitry. In yet another example, any one or more of recommendation operation modules 210₁-210₈ may be implemented as firmware embedded in one or more hardware devices. In still another example, any one or more of recommendation operation modules 210₁-210₈ may be implemented as a combination of computer code, hardware logic/electrical circuitry, and/or firmware.

Recommendation operation modules 210₁-210₈ are provided for illustrative purposes and are not intended to be limiting. Recommendation logic 206 may include recommendation operation module(s) other than the recommendation operation modules 210₁-210₈ discussed above. The other recommendation operation module(s) may also be implemented in hardware, software, firmware, or any combination thereof.

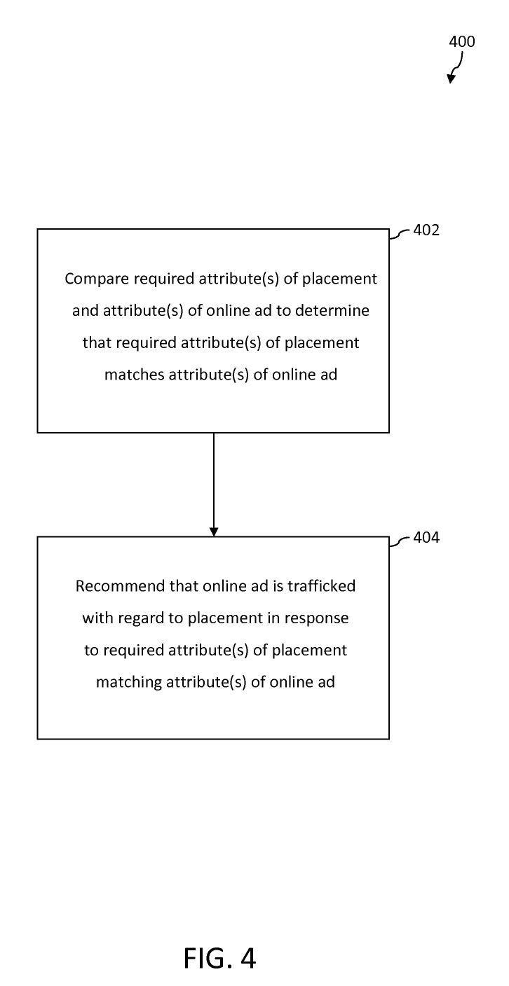

The example recommendation operations discussed above with reference to recommendation operation modules 210₁-210₈ are described in greater detail below in section V of the present application with reference to flowcharts 400, 500, and 600 depicted in respective FIGS. 4, 5, and 6.

### IV. Example Database Module

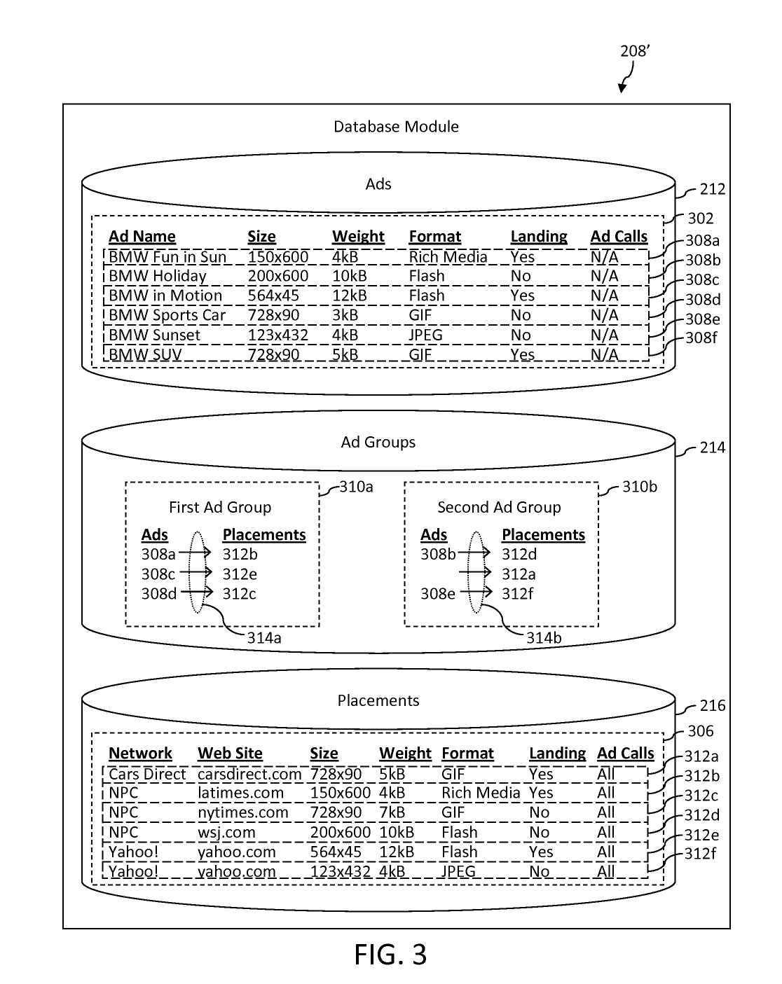

FIG. 3 is a block diagram of an example implementation 208′ of database module 208 shown in FIG. 2 in accordance with an embodiment of the present invention. As shown in FIG. 3, ads database 212 includes a list 302 of online ads 308a-308f and attributes thereof. The attributes of online ads 308a-308f depicted in FIG. 3 include an ad size attribute “Size”, an ad weight attribute “Weight”, an ad format attribute “Format”, a landing page attribute “Landing” indicating whether an ad is associated with landing page(s) (a.k.a. lead capture page(s)), and an ad call attribute “Ad Calls” indicating types of ad calls required by the ad. Persons skilled in the relevant art(s) will recognize that any suitable attributes may be stored in ads database 212 along with the ads.

Ad size is representative of the dimensions of an ad. For example, online ad 308a has an area of 150 pixels by 600 pixels. Ad weight represents the number of bytes necessary to store the online ad. For instance, the ad weight attribute of online ad 308a indicates that online ad 308a consumes 4 kilobytes in ads database 212. Ad format is representative of the technique used to compress or organize the contents of the online ad. Example formats include but are not limited to Adobe® Flash®, Graphics Interchange Format (GIF), JPEG, rich media, etc.

An online ad is said to be associated with a landing page if the online ad is configured to direct a viewer of the online ad to a web site (i.e., the landing page) when the viewer clicks the online ad. For instance, the landing page attributes of online ads 308a and 308c indicate that online ads 308a and 308c are associated with respective landing pages. An online ad may be compatible with only particular types of ad calls, in which case the ad call attribute of the online ad includes a list of the ad call types with which the online ad is compatible. As shown in FIG. 3, the ad call attribute of each online ad 308a-308f is specified as “N/A”, meaning that none of the online ads 308a-308f requires particular types of ad calls.

Placements database 216 includes a list 306 of placements 312a-312f and required attributes thereof. For example, an online ad having attributes that match the corresponding required attributes of a placement may be trafficked with regard to that placement. The required attributes of placements 312a-312f depicted in FIG. 3 are the same as the attributes provided with respect to online ads 308a-308f for ease of discussion. It will be recognized that the attributes of online ads 308a-308f stored in ads database 212 and the required attributes of placements 312a-312f stored in placements database 216 need not necessarily be the same, though online ads 308a-308f have at least one attribute in common with placements 312a-312f to facilitate matching.

The ad weight attribute “Weight” of each placement 312a-312f indicates a maximum weight of an ad that may be trafficked with regard to that placement. For instance, the ad weight attribute of placement 312a is specified as “5 kB”, indicating that online ads having an ad weight less than or equal to 5 kilobytes may be trafficked with regard to placement 312a.

The landing page attribute “Landing” of each placement 312a-312f indicates whether an ad that is associated with landing page(s) may be trafficked with regard to that placement. For example, the landing page attributes of placements 312a, 312b, and 312e are specified as “Yes”, indicating that ads may be trafficked with regard to placements 312a, 312b, and 312e regardless whether the ads are associated with landing page(s), so long as the ads satisfy the other required attributes of respective placements 312a, 312b, and 312e.

The ad call attribute “Ad Calls” of each placement 312a-312f indicates the types of ad calls supported by that placement. For instance, the ad call attribute may include a list of the ad call types supported by the placement. In FIG. 3, the ad call attribute of each placement 312a-312f is specified as “All”, meaning that the placements 312a-312f support all available ad call types.

Each of the placements 312a-312f is associated with a network and a corresponding web site with which the respective placement is to be served. For instance, placement 312a is to be served in the Cars Direct network on a web site having the uniform resource locator (URL) www.carsdirect.com. A network may include a plurality of web sites. For example, the NPC network is shown in FIG. 3 to include web sites for the Los Angeles Times (www.latimes.com), the New York Times (www.nytimes.com), and the Wall Street Journal (www.wsj.com).

Ad groups database 214 includes a first ad group 310a and a second ad group 310b, each of which includes online ads that are trafficked with regard to respective placements. For example, first ad group 310a includes online ads 308a, 308c, and 308d, which are trafficked with regard to respective placements 312b, 312e, and 312c as indicated by arrows 314a. Second ad group 310b includes online ads 308b and 308e, which are trafficked with regard to respective placements 312d and 312f as indicated by arrows 314b. In second ad group 310b, an online ad has not yet been trafficked with regard to placement 312a. For instance, an advertiser may obtain a recommendation of an online ad stored in ads database 212 for trafficking with regard to placement 312a in accordance with the recommendation techniques described herein.

As shown in FIG. 3, placement 312a requires an ad having an ad size of 728×90, an ad weight less than or equal to 5 kilobytes, and a GIF ad format, as indicated by respective required attributes of placement 312a. Online ads that are associated with landing pages may be trafficked with regard to placement 312a, as indicated by the landing page attribute of placement 312a. The ad call attribute of placement 312a indicates that placement 312a supports all available types of ad calls.

It will be apparent to persons skilled in the relevant art(s) that online ads 308d and 308f satisfy the required attributes of placement 312a. For example, each of online ads 308d and 380f has an ad size of 728×90, an ad weight less than or equal to 5 kilobytes, and a GIF format. Although online ad 308f is associated with a landing page, the landing page attribute of placement 312a indicates that placement 312a does not prohibit such ads. Finally, online ads 308d and 308f do not require particular types of ad calls, but even if they did, placement 312a supports all available types of ad calls, as indicated by the ad call attribute of placement 312a. Accordingly, ad recommendation module 106 may recommend online ads 308d and/or 308f for trafficking with regard to placement 312a.

### V. Example Recommendation Techniques

Some example methods for providing recommendations for trafficking online ads will now be described with reference to flowcharts 400, 500, and 600 of respective FIGS. 4, 5, and 6 in accordance with embodiments of the present invention. These methods are described by way of example only and are not intended to limit the scope of the present invention. Flowcharts 400, 500, and 600 may be performed by ad recommendation module 106 of online ad network 100 shown in FIG. 1, for example. For illustrative purposes, flowcharts 400, 500, and 600 are described with respect to example ad recommendation module 106′ shown in FIG. 2. Further structural and operational embodiments will be apparent to persons skilled in the relevant art(s) based on the discussion regarding flowcharts 400, 500, and 600.

As shown in FIG. 4, the method of flowchart 400 begins at step 402 in which compare module 210₃ compares required attribute(s) of a placement and attribute(s) of an online ad to determine that the required attribute(s) of the placement matches the attribute(s) of the online ad.

At step 404, recommendation module 210₄ recommends that the online ad is trafficked with regard to the placement in response to the required attribute(s) of the placement matching the attribute(s) of the online ad. For example, if the placement is designated for trafficking, recommendation module 210₄ may recommend the online ad to be trafficked with regard to the designated placement. In another example, if the online ad is designated to be trafficked, recommendation module 210₄ may recommend the placement for trafficking the designated online ad.

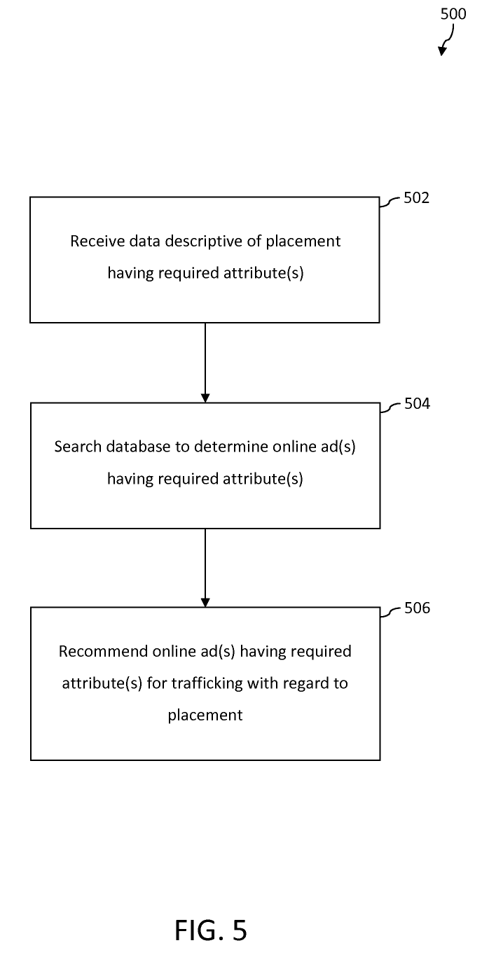

FIG. 5 is a flowchart 500 of a method that may be used to determine a recommended online ad for trafficking with regard to a designated placement. As shown in FIG. 5, the method of flowchart 500 begins at step 502 in which retrieve/store module 210₁ receives data descriptive of a placement (e.g., a designated placement) having required attribute(s). For instance, the data may include data descriptive of required attributes of the placement.

At step 504, search module 210₂ searches a database to determine online ad(s) having the required attribute(s). For example, search module 210₂ may search ads database 212 and provide first data descriptive of attributes of the online ads to compare module 210₃. Compare module 210₃ may compare the first data with second data, which is descriptive of the required attribute(s) of the placement, to determine the online ad(s) having the required attribute(s).

At step 506, recommend module 210₄ recommends the online ad(s) having the required attribute(s) for trafficking with regard to the placement.

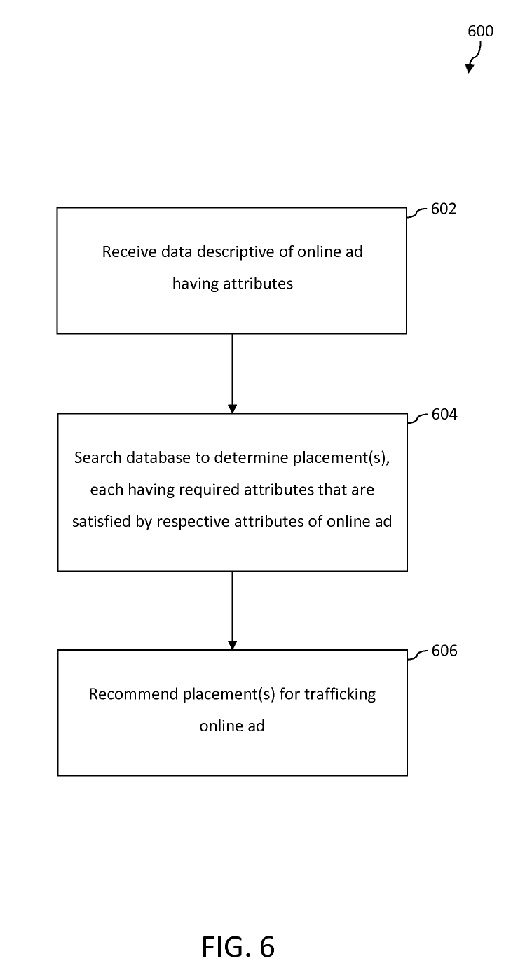

FIG. 6 is a flowchart 600 of a method that may be used to determine recommended placement(s) for trafficking a designated online ad. As shown in FIG. 6, the method of flowchart 600 begins at step 602 in which retrieve/store module 210₁ receives data descriptive of an online ad (e.g., a designated online ad) having attributes. For instance, the data may include data descriptive of the attributes of the online ad.

At step 604, search module 210₂ searches a database to determine placement(s), each having required attributes that are satisfied by the respective attributes of the online ad. For example, search module 210₂ may search placements database 216 and provide first data descriptive of the required attributes of the placements to compare module 210₃. Compare module 210₃ may compare the first data with second data, which is descriptive of the attributes of the online ad, to determine the placement(s) having the required attributes that are satisfied by the respective attributes of the online ad.

At step 606, recommend module 210₄ recommends the placement(s) for trafficking the online ad.

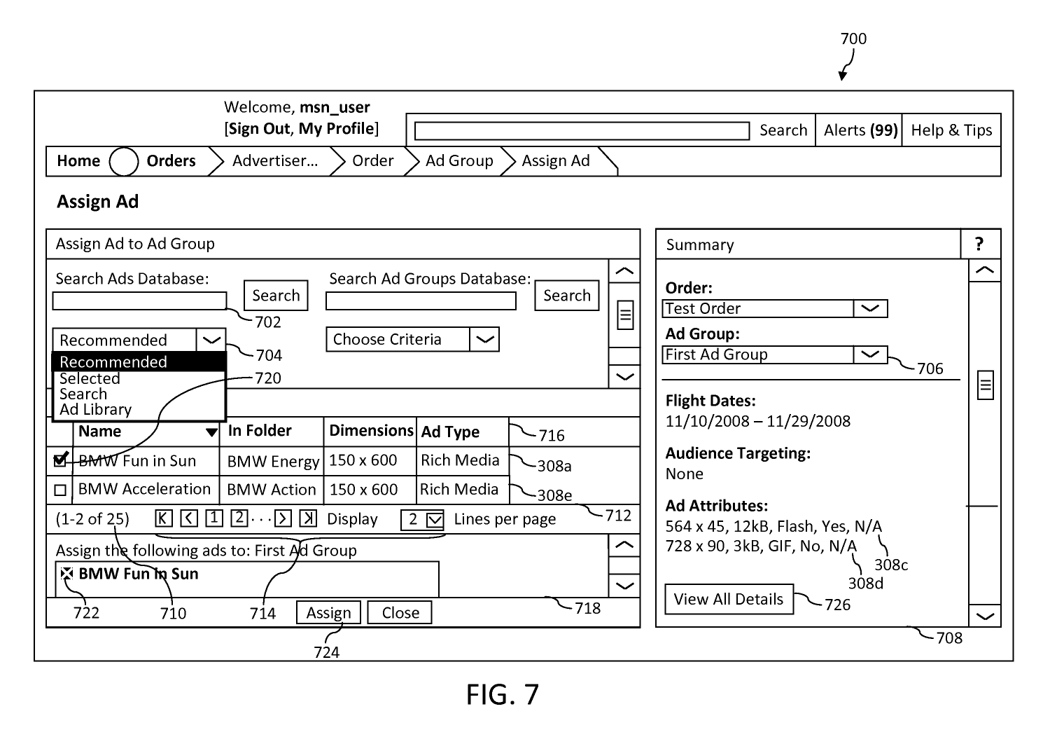

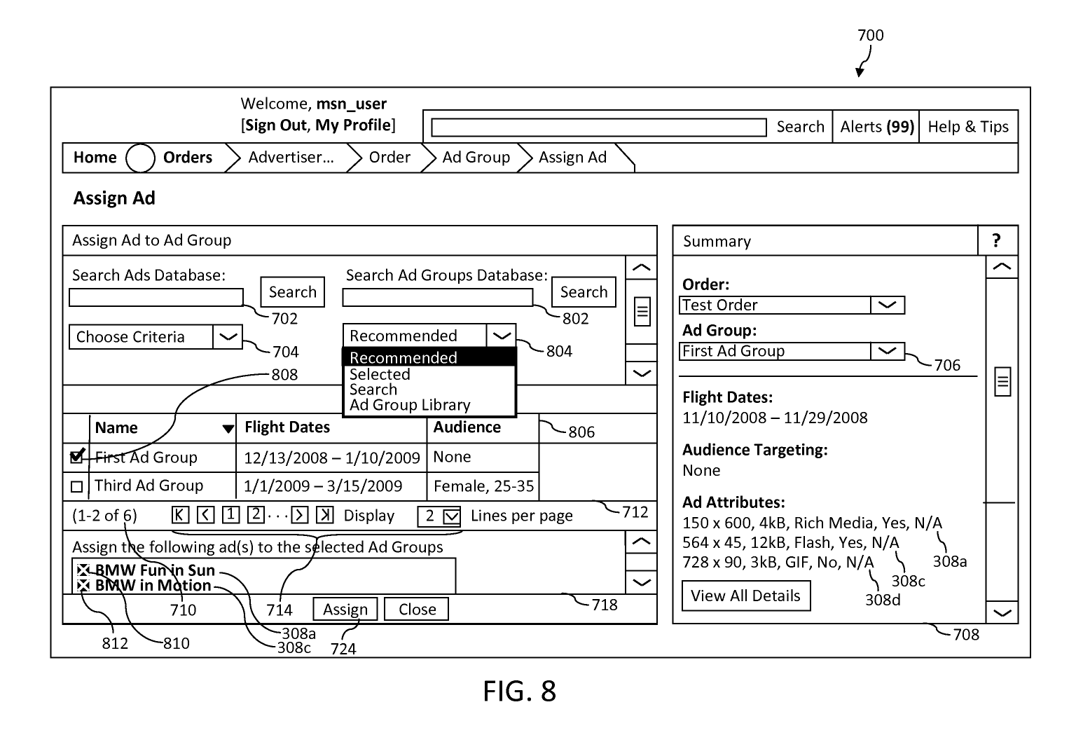

FIGS. 7 and 8 are illustrations of example Web pages showing a user interface for enabling a user (e.g., an advertiser or representative thereof) to request a recommendation for trafficking online ad(s) and to view corresponding recommendations generated by an ad recommendation module, such as ad recommendation module 106, in accordance with embodiments of the present invention. FIG. 7 shows that the user interface may be used to obtain recommended online ads and to assign one or more of the recommended online ads to a designated ad group. FIG. 8 shows that the user interface may be used to obtain recommended ad group(s) and to assign designated online ad(s) to one or more of the recommend ad group(s).

Ad recommendation module 106 serves the user interface in the form of Web pages to a Web browser of a system/device, such as advertiser system/device 102, which displays the user interface to the user in the Web browser. The user interface illustrated by the example Web pages of FIGS. 7 and 8 is provided by way of example and is not intended to be limiting. It will be apparent to persons skilled in the relevant art(s) that a user may utilize any suitable user interface to obtain recommendations for trafficking online ads. Moreover, the user interface need not necessarily be provided by ad recommendation module 106. For instance, the user interface may be generated by the user.

Referring to FIG. 7, a user designated as “msn_user” is logged into a computer system that provides access to the user interface. For example, recommendation processing module 202 may execute instructions stored in recommendation logic 206 of FIG. 2 to provide access to the user interface. The user may utilize search tool 702 to search ads database 212 for online ads to assign to an ad group designated in ad group menu 706. Ad group menu 706 may be a pop-up, drop-down, or equivalent menu, or other graphical interface element. Recommendation processing module 202 may execute instructions stored in search module 210₂ of FIG. 2 to provide the functionality associated with search tool 702. The first ad group is designated in ad group menu 706 for illustrative purposes. It will be recognized that the user may designate a different ad group that is stored in ad groups database 214 by choosing the ad group from those listed in ad group menu 706.

Online ad search type menu 704 enables the user to search among online ads grouped based on a variety of predetermined criteria. Online ad search type menu 704 may be a pop-up, drop-down, or equivalent menu, or other graphical interface element. Selecting the “Recommended” item of online ad search type menu 704, as illustrated in FIG. 7, enables the user to search among online ads recommended by ad recommendation module 106. Ad recommendation module 106 may recommend one or more online ads in accordance with any of the ad recommendation techniques described herein in response to the user selecting the “Recommended” item. For example, ad recommendation module 106 may provide recommended online ads based on the attributes of the online ads matching the required attributes associated with the ad group designated in ad group menu 706 (i.e., the first ad group in this example). The “View All Details” button 726 in window 708 enables the user to view a list of the placements and corresponding required attributes that are associated with the ad group designated in ad group menu 706.

Online ads 308c and 308d are currently included in (i.e., assigned to) the first ad group as depicted in window 708. Ad recommendation module 106 recommends twenty-five online ads for assignment to the first ad group, as indicated by counter 710, in response to the user selecting the “Recommended” item. Two of the recommended online ads (i.e., online ads 308a and 308e) are shown in window 712. The names and corresponding information of the remaining recommended online ads are accessible by using buttons 714. If the user performs a search in this example, the scope of the search is restricted to the twenty-five recommended online ads, meaning that the search results cannot include ads other than those that have been recommended by ad recommendation module 106.

The user may select or deselect the checkbox corresponding to each online ad listed in table 716, causing the ad to be listed or delisted, respectively, in window 718. Each ad having a selected checkbox is listed in window 718, indicating that the ad is in queue to be assigned to the designated ad group (e.g., the first ad group in FIG. 7). An ad listed in window 718 may be deleted from window 718 by deselecting the checkbox corresponding to that ad in table 716 or by selecting the icon next to the name of the ad in window 718. For instance, the user may delete the ad named “BMW Fun in Sun” from window 718 by deselecting checkbox 720 in table 716 or by selecting icon 722 in window 718. The user may assign ads listed in window 718 to the designated ad group by pressing the “Assign” button 724.

It should be noted that online ad search type menu 704 also enables the user to search among online ads grouped based on predetermined criteria other than recommendations provided by ad recommendation module 106. For example, the “Selected” item of online ad search type menu 704 enables a user to search among online ads that have been selected by the user. Thus, the scope of a search conducted in accordance with the “Selected” item is restricted to the selected ads. For instance, recommendation processing module 202 may execute instructions stored in search module 210₂ of FIG. 2 to determine which ads have been selected by the user in response to the user selecting the “Selected” item of menu 704. Recommendation processing module 202 may then search the selected ads in accordance with instructions stored in search module 210₂.

The “Search” item of online ad search type menu 704 enables the user to search the entirety of ads database 212 for an online ad. For instance, recommendation processing module 202 may search the entirety of ads database 212 in accordance with instructions stored in search module 210₂ in response to the user selecting the “Search” item.

The “Ad Library” item enables the user to browse a hierarchical folder structure and to select a folder therein to be searched for one or more online ads. Thus, the scope of a search conducted in accordance with the “Ad Library” item is restricted to the ads in the selected folder or in sub-folders thereof. For instance, recommendation processing module 202 may execute instructions stored in search module 210₂ to enable the user to browse the hierarchical folder structure and to select a folder therein in response to the user selecting the “Ad Library” item. Recommendation processing module 202 may then search for the ad(s) in the selected folder in accordance with instructions stored in search module 210₂.

Referring to FIG. 8, the user may utilize search tool 802 to search ad groups database 214 for ad groups to which online ad(s) designated in window 718 may be assigned. For example, the user may designate the online ad(s) in accordance with techniques described above with reference to FIG. 7 or other techniques. Recommendation processing module 202 may execute instructions stored in search module 210₂ of FIG. 2 to provide the functionality associated with search tool 802.

Ad group search type menu 804 enables the user to search among ad groups that are grouped based on a variety of predetermined criteria. Ad group search type menu 804 may be a pop-up, drop-down, or equivalent menu, or other graphical interface element. Selecting the “Recommended” item of ad group search type menu 804, as illustrated in FIG. 8, enables the user to search among ad groups recommended by ad recommendation module 106. Ad recommendation module 106 may recommend one or more ad groups in accordance with any of the ad recommendation techniques described herein in response to the user selecting the “Recommended” item. For example, ad recommendation module 106 may provide recommended ad groups based on the required attributes associated with the ad groups matching the attributes of one or more of the online ad(s) designated in window 718.

Ad recommendation module 106 recommends six ad groups to which the online ads designated in window 718 may be assigned, as indicated by counter 710, in response to the user selecting the “Recommended” item. Two of the recommended ad groups (i.e., the first and third ad groups) are shown in window 712. The names and corresponding information of the remaining recommended ad groups are accessible by using buttons 714. If the user performs a search in this example, the scope of the search is restricted to the six recommended ad groups, meaning that the search results cannot include ad groups other than those that have been recommended by ad recommendation module 106.

The user may select or deselect the checkbox corresponding to each ad group listed in table 806. The user may assign ads listed in window 718 to the ad groups that are selected in window 712 by pressing the “Assign” button 724. In the example of FIG. 8, pressing the “Assign” button assigns online ads 308a and 308c to the first ad group, which is shown to be selected in window 712, and to any of the other recommended ad groups that are selected.

It should be noted that ad group search type menu 804 also enables the user to search among ad groups that are grouped based on predetermined criteria other than recommendations provided by ad recommendation module 106. For example, the “Selected” item of ad group search type menu 804 enables a user to search among ad groups that have been selected by the user. Thus, the scope of a search conducted in accordance with the “Selected” item is restricted to the selected ad groups. For instance, recommendation processing module 202 may execute instructions stored in search module 210₂ of FIG. 2 to determine which ad groups have been selected by the user in response to the user selecting the “Selected” item of menu 804. Recommendation processing module 202 may then search the selected ad groups in accordance with instructions stored in search module 210₂.

The “Search” item of ad group search type menu 804 enables the user to search the entirety of ad groups database 214 for an ad group. For instance, recommendation processing module 202 may search the entirety of ad groups database 214 in accordance with instructions stored in search module 210₂ in response to the user selecting the “Search” item.

The “Ad Group Library” item enables the user to browse a hierarchical folder structure and to select a folder therein to be searched for one or more ad groups. Thus, the scope of a search conducted in accordance with the “Ad Group Library” item is restricted to the ad groups in the selected folder or in sub-folders thereof. For instance, recommendation processing module 202 may execute instructions stored in search module 210₂ to enable the user to browse the hierarchical folder structure and to select a folder therein in response to the user selecting the “Ad Group Library” item. Recommendation processing module 202 may then search for the ad group(s) in the selected folder in accordance with instructions stored in search module 210₂.

Embodiments described herein have a variety of benefits, as compared to conventional online ad networks, such as reducing the amount of involvement necessary for an advertiser (or representative thereof) to traffic online ads, as compared to conventional online ad networks. For instance, embodiments may partially or entirely automate the searching and/or comparing operations that are traditionally performed manually by advertisers when trafficking online ads. For example, embodiments may reduce or eliminate the need for an advertiser to manually search through databases of ads, ad groups, and/or placements in order to match attributes of online ads with required attributes of placements.

The advertiser may be able to traffic substantially more online ads within a given time period using the embodiments described herein, as compared to conventional online ad networks. Embodiments may enable the advertiser to exclude online ads, ad groups, and/or placements that do not satisfy designated requirements from consideration or review. A greater proportion of the advertiser's time may be allocated to tasks other than trafficking online ads. For instance, the advertiser may be able to spend more time researching, creating new online ads, etc. Embodiments may reduce the cost associated with trafficking online ads.

### VI. Example Computer System Implementation

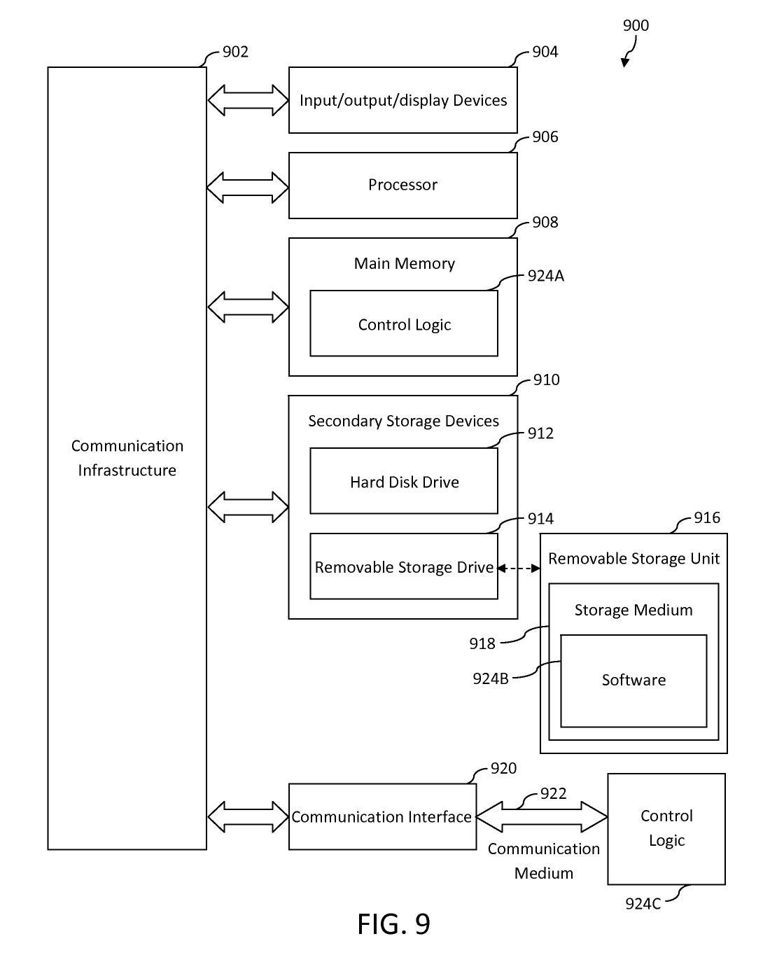

The embodiments described herein, including systems, methods/processes, and/or apparatuses, may be implemented using well known servers/computers, such as computer 900 shown in FIG. 9. For example, elements of example online ad network 100, including ad recommendation module 106 depicted in FIGS. 1 and 2, and each of the steps of flowcharts 400, 500, and 600 depicted in respective FIGS. 4, 5, and 6, can each be implemented using one or more computers 900.

Computer 900 can be any commercially available and well known computer capable of performing the functions described herein, such as computers available from International Business Machines, Apple, Sun, HP, Dell, Cray, etc. Computer 900 may be any type of computer, including a desktop computer, a server, etc.

As shown in FIG. 9, computer 900 includes one or more processors (e.g., central processing units (CPUs)), such as processor 906. Processor 906 may include recommendation processing module 202 of FIG. 2 or a portion thereof, for example, though the scope of the embodiments is not limited in this respect. Processor 906 is connected to a communication infrastructure 902, such as a communication bus. In some embodiments, processor 906 can simultaneously operate multiple computing threads.

Computer 900 also includes a primary or main memory 908, such as a random access memory (RAM). Main memory has stored therein control logic 924A (computer software), and data.

Computer 900 also includes one or more secondary storage devices 910. Secondary storage devices 910 include, for example, a hard disk drive 912 and/or a removable storage device or drive 914, as well as other types of storage devices, such as memory cards and memory sticks. For instance, computer 900 may include an industry standard interface, such as a universal serial bus (USB) interface for interfacing with devices such as a memory stick. Removable storage drive 914 represents a floppy disk drive, a magnetic tape drive, a compact disk drive, an optical storage device, tape backup, etc.

Removable storage drive 914 interacts with a removable storage unit 916. Removable storage unit 916 includes a computer useable or readable storage medium 918 having stored therein computer software 924B (control logic) and/or data. Removable storage unit 916 represents a floppy disk, magnetic tape, compact disc (CD), digital versatile disc (DVD), Blue-ray disc, optical storage disk, memory stick, memory card, or any other computer data storage device. Removable storage drive 914 reads from and/or writes to removable storage unit 916 in a well known manner.

It will be apparent to persons skilled in the relevant art(s) that storage 204 of FIG. 2 or a portion thereof (e.g., any one or more of recommendation operation modules 210₁-210₈ and/or any one or more of databases 212, 214, and 216) may be included in main memory 908, secondary memory 910, removable storage unit 916, or some combination thereof, though the scope of the embodiments is not limited in this respect.

Computer 900 also includes input/output/display devices 904, such as monitors, keyboards, pointing devices, etc.

Computer 900 further includes a communication or network interface 920. Communication interface 920 enables computer 900 to communicate with remote devices. For example, communication interface 920 allows computer 900 to communicate over communication networks or mediums 922 (representing a form of a computer useable or readable medium), such as local area networks (LANs), wide area networks (WANs), the Internet, etc. Network interface 920 may interface with remote sites or networks via wired or wireless connections. Examples of communication interface 922 include but are not limited to a modem, a network interface card (e.g., an Ethernet card), a communication port, a Personal Computer Memory Card International Association (PCMCIA) card, etc.

Control logic 924C may be transmitted to and from computer 900 via the communication medium 922.

Any apparatus or manufacture comprising a computer useable or readable medium having control logic (software) stored therein is referred to herein as a computer program product or program storage device. This includes, but is not limited to, computer 900, main memory 908, secondary storage devices 910, and removable storage unit 916. Such computer program products, having control logic stored therein that, when executed by one or more data processing devices, cause such data processing devices to operate as described herein, represent embodiments of the invention.

For example, each of the elements of example online ad network 100, including ad recommendation module depicted in FIGS. 1 and 2 and its sub-elements, and each of the steps of flowcharts 400, 500, and 600 depicted in respective FIGS. 4, 5, and 6 can be implemented as control logic that may be stored on a computer useable medium or computer readable medium, which can be executed by one or more processors to operate as described herein.

The invention can be put into practice using software, hardware, and/or operating system implementations other than those described herein. Any software, hardware, and operating system implementations suitable for performing the functions described herein can be used.

### VII. Conclusion

While various embodiments of the present invention have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system comprising:
a processing module; and
a storage coupled to the processing module for storing
a database module that includes online advertisements and placements,
a first recommendation operation module for enabling the processing module to compare at least one required attribute of a placement and at least one attribute of an online advertisement to determine that the at least one required attribute of the placement matches the at least one attribute of the online advertisement, and
a second recommendation operation module for enabling the processing module to recommend that the online advertisement is trafficked with regard to the placement in response to the at least one required attribute of the placement matching the at least one attribute of the online advertisement.

2. The system of claim 1, wherein the placement is associated with an ad group, and wherein the second recommendation operation module is configured to enable the processing module to recommend the ad group from a plurality of ad groups for inclusion of the online advertisement.

3. The system of claim 1, wherein the placement is associated with an ad group, and wherein the second recommendation operation module is configured to enable the processing module to recommend the online advertisement from among a plurality of online advertisements for inclusion in the ad group.

4. A method comprising:
receiving data descriptive of a placement having at least one required attribute;
searching a database to determine one or more online advertisements having the at least one required attribute; and
recommending the one or more online advertisements for trafficking with regard to the placement.

5. The method of claim 4, wherein receiving the data includes receiving a request for a recommendation of an online advertisement for inclusion in an ad group, and wherein recommending the one or more online advertisements includes recommending the one or more online advertisements for inclusion in the ad group.

6. The method of claim 4, wherein searching the database includes comparing the at least one required attribute to a corresponding at least one attribute for each of a plurality of online advertisements to determine the one or more online advertisements having the at least one required attribute.

7. The method of claim 4, wherein the database is associated with a designated advertiser.

8. The method of claim 4, wherein the searching is limited to user-selected online advertisements.

9. The method of claim 4, wherein the searching is limited to user-selected folders of a hierarchical folder structure.

10. The method of claim 4, further comprising:
filtering the recommended one or more online advertisements based on at least one user-specified criterion.

11. The method of claim 4, wherein the at least one required attribute includes at least one of an ad size, an ad weight, or an ad format.

12. A method comprising:
receiving data descriptive of an online advertisement having attributes;
searching a database to determine one or more placements, each having required attributes that are satisfied by the respective attributes of the online ad; and
recommending the one or more placements for trafficking the online advertisement.

13. The method of claim 12, wherein receiving the data includes receiving a request for a recommendation of an ad group to include the online advertisement, and wherein recommending the one or more placements includes recommending one or more ad groups associated with the respective one or more placements.

14. The method of claim 13, wherein the searching is limited to user-selected ad groups.

15. The method of claim 12, wherein the searching is limited to user-selected folders of a hierarchical folder structure.

16. The method of claim 12, wherein the attributes of the online advertisement include at least one of a size, a weight, or a format of the online advertisement.

17. A computer program product comprising a computer-readable medium having computer program logic recorded thereon for enabling a processor-based system to recommend one or more online advertisements for trafficking, comprising:
a first program logic module for enabling the processor-based system to compare at least one required attribute of a placement and at least one attribute of each of a plurality of online advertisements to determine that the at least one required attribute of the placement matches the at least one attribute of one or more advertisements of the plurality of online advertisements; and
a second program logic module for enabling the processor-based system to recommend the one or more advertisements for trafficking with regard to the placement in response to the at least one required attribute of the placement matching the at least one attribute of the one or more advertisements.

18. The computer program product of claim 17, further comprising:
a third program logic module for enabling the processor-based system to distinguish between first online advertisements that are selected by a user and second online advertisements that are not selected by the user and to exclude the second online advertisements from the plurality of online advertisements.

19. The computer program product of claim 17, further comprising:
a third program logic module for enabling the processor-based system to distinguish between first folders of a hierarchical folder structure that are selected by a user and second folders of the hierarchical folder structure that are not selected by the user and to limit the plurality of online advertisements to online advertisements in the first folders.

20. The computer program product of claim 17, further comprising:
a third program logic module for enabling the processor-based system to filter the recommended one or more online advertisements based on at least one user-specified criterion.
